(19) United States
(12) Patent Application Publication
(10) Pub. No.: US 2011/0069978 A1
(43) Pub. Date: Mar. 24, 2011

(54) IMAGE FORMING APPARATUS

(75) Inventor: Shinya Yamamoto, Numazu-shi (JP)

(73) Assignee: CANON KABUSHIKI KAISHA, Tokyo (JP)

(21) Appl. No.: 12/884,415

(22) Filed: Sep. 17, 2010

(30) Foreign Application Priority Data
Sep. 18, 2009 (JP) 2009-216900
Jul. 14, 2010 (JP) 2010-159297

(51) Int. Cl. G03G 15/08

(52) U.S. Cl. 399/27

(57) ABSTRACT

An image forming apparatus includes an image bearing member for bearing an electrostatic latent image on a surface thereof; a developing device including a developer accommodating chamber for accommodating a developer, a developer carrying member, provided in the developer accommodating chamber and having a first electrode member, for developing the electrostatic latent image, a developer feeding member, provided in the developer accommodating chamber in contact with the developer carrying member and having a foam layer around a second electrode member, for supplying the developer to the developer carrying member; a holding unit holding the developing device, the holding unit being movable between a first position in which the developer is accumulated on a nip between the developer carrying member and the developer feeding member and a second position in which the developer accumulated at the nip in the first position falls; and a detecting device for detecting a developer remainder amount in the developer accommodating chamber on the basis of a change of an electrostatic capacity between the first electrode member and the second electrode member.

### FIELD OF THE INVENTION AND RELATED ART

The present invention relates to image forming apparatuses such as electrophotographic copying machines, electrophotographic printers, etc.

The inventors of the present invention have proposed a method for detecting the amount of the developer (which hereafter may be referred to as toner) remaining in a developing apparatus (which hereafter may be referred to as developing device) (Japanese Laid-open Patent Application H04-234777). This method is for detecting the amount of the toner remaining in a developing device equipped with a toner bearing member for developing an electrostatic latent image by supplying an image bearing member with toner, a toner supplying member for supplying the toner bearing member with toner by being in contact with the toner bearing member. More concretely, a developing device is provided with a member for coating a toner bearing member with toner (toner bearing member coating member). The toner bearing member coating member is supported by an electrically conductive member, so that an alternating voltage can be applied to the toner bearing member from a development bias power source. Thus, the amount of the toner remaining in the developing device is detected (estimated) by measuring the voltage induced in the electrically conductive supporting member for the developer bearing member coating member. The magnitude of the voltage induced in the electrically conductive supporting member is affected by the amount of the electrostatic capacity between the toner bearing member and electrically conductive supporting member. When a developing device is full of toner, the area between its toner bearing member and electrically conductive supporting member is full of toner. However, as the toner in the developing device is consumed, the area between the toner bearing member and electrically conductive supporting member reduces. Thus, the amount of the electrostatic capacity of the area between the toner bearing member and electrically conductive supporting member when the developing device is full of toner, is different from that when the amount of the toner in the developing device has been reduced by consumption. Therefore, the amount of voltage induced in the electrically conductive member when the developing device is full of toner, is different from that when the amount of the toner in the developing device is less because of the consumption. This phenomenon is used to detect (estimate) the amount of the toner in the developing device. This method does not require a space dedicated to the detection (estimation) of the amount of the toner remaining in a developing device.

It has become evident that the above described prior art suffers from the problem that even if no toner in a developing device is consumed, the amount of the electrostatic capacity between the toner bearing member and electrically conductive supporting member is affected by the changes in the toner density in the developing device. Ordinarily, during an image forming operation, the toner in a developing device in an image forming apparatus is circulated in the device, while being fully stirred, by the rotation of the toner bearing member, and the rotation or the like of the toner conveying member. However, if the developing device in the image forming apparatus is kept unattended for a long time after the completion of the image forming operation, the body of the toner in the developing device becomes packed downward by its own weight, increasing in density. Consequently, the area between the toner bearing member and development bearing member coating member is increased in toner density. In other words, even if the developing device remains the same in the amount of the toner therein, it sometimes varies in the detected amount of the electrostatic capacity between the toner bearing member and toner bearing member coating member. In order to solve this problem, the developing device has to be made uniform in toner density before the amount of the toner in the developing device is detected. In other words, before the amount of the toner in the developing device is detected, the developing device has to be rotated to stir the toner in the developing device to make the toner uniform in density. Thus, a certain length of time is necessary each time the toner remainder amount in the developing device is detected. This results in the reduction in the throughput of the image forming apparatus. In addition, the additional driving of the developing device contributes to the further frictional wear and deterioration of the developing device, being therefore likely to affect the service life of the developing device.

The present invention is intended to improve the above described prior art which relates to the toner remainder amount detecting function of an image forming apparatus and a developing device therefor. Thus, the primary object of the present invention is to provide an image forming apparatus capable of accurately detecting (estimating) the amount of the toner remaining in its developing device(s) regardless of the environment in which the developing device (image forming apparatus) is used, and/or the condition in which the developing device (image forming apparatus) is left unattended.

### SUMMARY OF THE INVENTION

The primary object of the present invention is to provide an image forming apparatus capable of accurately detecting (estimating) the amount of the toner remaining in its developing device(s) regardless of the environment in which the developing device (image forming apparatus) is used, and/or the condition in which the developing device (image forming apparatus) is left unattended.

According to an aspect of the present invention, there is provided an image forming apparatus comprising an image bearing member for bearing an electrostatic latent image on a surface thereof; a developing device including a developer accommodating chamber for accommodating a developer, a developer carrying member, provided in said developer accommodating chamber and having a first electrode member, for developing the electrostatic latent image, a developer feeding member, provided in said developer accommodating chamber in contact with said developer carrying member and having a foam layer around a second electrode member, for supplying the developer to said developer carrying member; a holding unit holding said developing device, said holding unit being movable between a first position in which the developer is accumulated on a nip between said developer carrying member and said developer feeding member and a second position in which the developer accumulated at said nip in the first position falls; and a detecting device for detecting a developer remainder amount in said developer accommodating chamber on the basis of a change of an electrostatic capacity between said first electrode member and said second electrode member.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1(a) is a schematic sectional view of the image forming apparatus in the first preferred embodiment of the present invention, and shows the general structure of the apparatus. FIG. 1(b) is an enlarged schematic sectional view of the developing device of the apparatus shown in FIG. 1(a), and shows the developing apparatus when it is in its first position.

FIG. 2(a) is an enlarged schematic sectional view of the developing device of the apparatus shown in FIG. 1(a), and shows the developing apparatus when it is in its second position. FIG. 2(b) is a schematic drawing of the developing apparatus, and the components related to the operation of the developing apparatus, and shows the method for measuring the amount of airflow through the developer application roller.

FIG. 3(a) is a graph which shows the relationship between the amount of the toner in the developing device, and the amount of the toner in the sponge portion of the developer application roller. FIG. 3(b) is a graph which shows the relationship between the amount of the toner in the sponge portion of the developer application roller, and the amount of the electrostatic capacity.

FIG. 4(a) is a graph which shows the relationship between the changes in the amount of the electrostatic capacity detected by a toner remainder amount detecting apparatus immediately after the developing device was moved to its second position, and the length of time which elapsed after the movement of the detecting apparatus. FIG. 4(b) is a graph which shows the relationship between the amount of the output of the toner remainder amount detecting apparatus, and the amount of the toner remainder in the developer container.

FIG. 5(a) is a block diagram of the toner remainder amount detecting apparatus, and FIG. 5(b) is a graph which shows the relationship between the amount (weight) of the body of toner in the developing device, and the toner remainder amount detection output.

FIG. 6(a) is a schematic sectional view of the developing device of the image forming apparatus in the second preferred embodiment, when the developing device is in its first attitude. FIG. 6(b) is a combination of a schematic sectional view of the developing device in the second embodiment, when the device is in its second attitude, and a block diagram of the developer remainder amount detecting apparatus in the second embodiment.

FIG. 7(a) is a graph which shows the relationship between the changes in the amount of the electrostatic capacity detected by the toner remainder amount detecting apparatus immediately after the developing device was moved to its second position, and the length of time which elapsed after the movement of the detecting apparatus. FIG. 7(b) is a graph which shows the change in the relationship between the amount of the output of the toner remainder amount detecting apparatus, and the amount of the toner in the developer container.

### DESCRIPTION OF THE PREFERRED EMBODIMENTS

### Embodiment 1

Hereinafter, the preferred embodiments of the present invention will be described in detail with reference to the appended drawings. Incidentally, the measurement and shape of the structural components of the image forming apparatus in each of the preferred embodiments of the present invention, and the positional relationship among them, should be altered as necessary according to the structure of an apparatus to which the present invention is applied, and the various conditions under which the apparatus is used. In other words, the following embodiments of the present is not intended to limit the present invention in scope.

### <General Structure of Image Forming Apparatus>

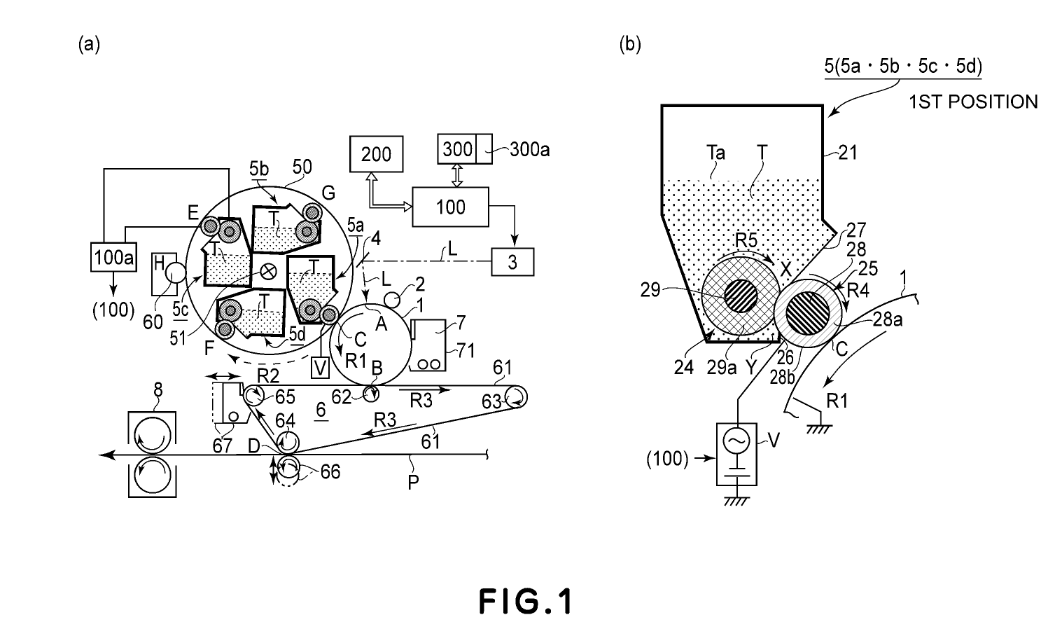

FIG. 1(a) is a schematic sectional view of the image forming apparatus in this embodiment, and shows the general structure of the apparatus. This image forming apparatus is an electrophotographic full-color image forming apparatus which uses four developers different in color. This image forming apparatus forms an image on recording medium P, which is in the form of a sheet, based on the electrical image formation signal inputted into the controller portion 100 (controlling means: CPU) of the apparatus from a host apparatus 200, such as an image reader (original reading apparatus), a personal computer, a facsimile, etc. The controller portion 100 (which hereafter will be referred to simply as controller 100) exchanges various electrical information with the host apparatus 200, and the control panel portion 300 of the image forming apparatus, and also, controls the overall operation of the image forming apparatus, based on preset control programs and referential tables. The image forming apparatus has an electrophotographic photosensitive member 1 (which hereafter will be referred to as drum 1), which is a rotatable image bearing member, on the peripheral surface of which an electrostatic latent image is. It has also: a charging means 2, which is a processing means for processing the peripheral surface of the drum 1; a drum exposing means 3; developing apparatuses 5 (5a, 5b, 5c, and 5d); a transferring means 6; and a drum cleaning means 7. The drum 1 is rotated about its axis at a preset speed in the counterclockwise direction, that is, the direction indicated by an arrow mark R1. The charging means 2 is a means which uniformly charges the peripheral surface of the drum 1 to preset polarity (which in this embodiment is negative) and potential level. The charging means 2 in this embodiment is a charge roller of the contact type. The drum exposing means 3 is a means which forms an electrostatic latent image on the peripheral surface of the drum 1. The drum exposing means 3 in this embodiment is a laser-based scanner unit. This unit 3 scans (exposes) the uniformly charged portion of the peripheral surface of the drum 1, in the drum exposing portion A. More specifically, the unit 3 projects a beam L of laser light upon a deflection mirror 4, while modulating the beam L with image formation information inputted, one for each of primary colors, into the controller 100 from the host apparatus 200. Thus, the uniformly charged portion of the peripheral surface of the drum 1 is scanned by the beam L deflected by the mirror 4. Consequently, an electrostatic latent image is effected on the peripheral surface of the drum 1. The electrostatic latent image forming method used in this embodiment is such a drum exposing method that exposes the uniformly charged portion of the peripheral surface of the drum 1 according to the image formation information. The developing apparatus 5 is a means for developing the electrostatic latent image on the peripheral surface of the drum 1 into a visible image, that is, an image formed of developer (toner), which hereafter may be referred to as a developer image or a toner image. The image forming apparatus in this embodiment has multiple developing devices (developing apparatuses), more specifically, first to fourth developing apparatuses 5 (5a, 5b, 5c, and 5d, which are in the form of a cartridge (development cartridge)). These developing devices are held by a rotary 50, which is a developing device holding member (holder unit) rotatable about its central axis 51 in such a manner that a given developing device can be positioned in a preset position (in terms of the rotational angle of rotary 50). The rotary 50 is provided with four chambers in which the four developing devices 5 are removably mountable, one for one. The four developing device holding chambers extend in the direction parallel to the axial direction of the holder 50. The size of each chamber in terms of the angle in the rotational direction of the rotary 50 is 90 degrees. The rotary 50 is rotatable by a driving means (motor or the like, which is unshown in drawings), which is under the control of the controller 100. It is rotatable in steps of 90 degree angle, in the clockwise direction, that is, the direction indicated by an arrow mark R2. Thus, the first to fourth developing devices 5a, 5b, 5c, and 5d are sequentially movable to a development position C where they oppose the peripheral surface of the drum 1 and can develop the electrostatic latent image on the drum 1 into a toner image. Hereafter, the position into which any of the developing apparatuses in the rotary holder 50 is to be moved to oppose the drum 1 will be referred to as the position C of the developing apparatus 5. Further, a position into which a given developing device 5 is moved from the position C as the rotary 50 is rotated by 90° in the abovementioned direction, will be referred to as a position F. Further, the position into which the developing device 5 will be placed as the rotary 50 is rotated from the position F by 90 degrees (180° from position C) in the abovementioned direction, will be referred to as a position E. Further, the position in which the developing apparatus 5 will be as it is rotated 90° (270° from position C) from the position E in the abovementioned direction, will be referred to as a position G.

The first to fourth developing devices 5a, 5b, 5c, and 5d in this embodiment are of the contact type. They develop an electrostatic latent image in reverse with the use of developer T, which is nonmagnetic toner and is negatively chargeable. The developing device 5a, that is, the first developing device, is a developing device for developing an electrostatic latent image into a yellow toner image. It contains yellow (Y) toner in its developer storage chamber. The developing device 5b, that is, the second developing device, is a developing device for developing an electrostatic latent image into a magenta (M) toner image. It contains magenta (M) toner in its developer storage chamber. The developing device 5c, that is, the third developing device, is a developing device for developing an electrostatic latent image into a cyan toner image. It contains cyan (C) toner in its developer storage chamber. The developing device 5d, that is, the fourth developing device, is a developing device for developing an electrostatic latent image into a black (Bk) toner image. It contains black (Bk) toner in its developer storage chamber. The transferring means 6 is a means for transferring the toner image on the peripheral surface of the drum 1 onto recording medium. The transferring means 6 in this embodiment is in the form of an intermediary transfer belt unit, and may be referred to as an intermediary transfer belt unit, hereafter. This unit 6 has an intermediary transferring member 61, which is an intermediary transfer medium and is in the form of a dielectric and flexible endless belt. The unit 6 has also a first transfer roller 62, a belt driving roller 63 (driver roller), a backup roller 64 (which backs up endless belt against second transfer roller 66), and a tension roller 65. The first transfer roller 62 is kept pressed upon the peripheral surface of the drum 1 with the presence of the belt 61 between the roller 62 and drum 1. The area of contact between the drum 1 and belt 61 is the first transfer nip B. There is a second transfer roller 66, which is kept pressed upon the belt 61 (kept pressed against backup roller 64 with presence of the belt 61 between rollers 64 and 66). The second transfer roller 66 is movable by a second transfer roller moving mechanism (unshown), so that it can be kept in a position (first position) in which it is kept pressed against the belt-backing roller 64 with the presence of the belt 61 between the belt-backing roller 64 and second transfer roller 66, or a position (second position) in which it is kept separated from the belt 61. When the second transfer roller 66 is not used for transfer, it is kept in its second position. When it has to be used for transfer, it is moved into its first position with a preset timing. As the second transfer roller 66 is moved into the first position, a nip is formed between the second transfer roller 66 and belt 61. This nip is the second transfer nip D. The unit 6 has also a belt cleaning means 67, which is for cleaning the outward surface of the belt 61. The cleaning means 67 is in the adjacencies of where the belt 61 is in contact with the peripheral surface of the tension roller 65. The belt cleaning means 67 is movable by a belt cleaning means moving mechanism (unshown) so that it can be kept in a position (first position) in which its cleaning member is kept in contact with the outward surface of the belt 61, and a position (second position) in which the cleaning member is kept separated from the outward surface of the belt 61. When the cleaning means 67 is not used for cleaning, it is kept in the second position. When it has to be used for cleaning, it is moved into the first position with a preset timing. The drum cleaning means 7 is a means for removing the toner (first transfer residual toner) remaining on the peripheral surface of the drum 1 after the first transfer of the toner image onto the belt 61. It is in the form of a blade (cleaning blade). After being removed from the peripheral surface of the drum 1, the first transfer residual toner is stored in the cleaning means container 71. As an image formation start signal is inputted, the controller 100 begins to drive the main motor (unshown), whereby the drum 1 begins to be rotated in the counterclockwise direction, that is, the direction indicated by an arrow mark R1 at a preset speed. Further, the rotary 50 is rotated so that the first developing device 5a is moved into the position C. As the developing device 5a is moved into the position C, the driving force from the main motor begins to be transmitted to the developing device 5a, and a preset development bias is applied to the developing device 5a. Further, the laser-based scanner unit begins to be driven, and the belt 61 begins to be circularly driven in the clockwise direction, that is, the direction indicated by an arrow mark R3 (so that the peripheral surface of drum 1 and the peripheral surface of the developing member of developing device 5a move in the same direction in their interface) at a speed which corresponds to the rotational speed of the drum 1. As for the second transfer roller 66 and belt cleaning means 67, they are kept in their second positions where they remain separated from the belt 61. To the charge roller 2, a preset charge bias is applied. Thus, the peripheral surface of the rotating drum 1 is uniformly charged to preset polarity (which in this embodiment is negative) and potential level. The uniformly charged portion of the peripheral surface of the drum 1 is scanned (exposed) by the beam L of laser light outputted from the laser-based scanner unit 3, while being modulated with the image formation signals for the formation of a monochromatic image of the yellow component obtained by the color separation of the original full-color image. Consequently, an electrostatic image, which corresponds in pattern to the yellow monochromatic image to be formed on the peripheral surface of the drum 1, is effected on the peripheral surface of the drum 1. This electrostatic latent image is developed into a toner image (developer image) of yellow color by the first developing device 5a which is in the position C. In this embodiment, the electrostatic latent image is developed in reverse with the use of negative toner, that is, toner which is the same in polarity (negative) as the polarity to which the peripheral surface of the drum 1 is charged. Then, the yellow toner image is transferred (first transfer) onto the outward surface of the belt 61 in the first transfer nip B. In order to transfer (first transfer) the yellow toner image, a transfer bias (first transfer bias), which is preset in potential level and is opposite in polarity (positive) to the polarity to which toner is charged, is applied to the primary transfer roller 62 with preset control timing. After the first transfer, the peripheral surface of the drum 1 is cleaned by the drum cleaning means 7. After the completion of the first transfer of the yellow toner image, that is, the transfer of the yellow toner image onto the belt 61, the rotary 50 is rotated 90° in the clockwise direction, whereby the second developing device 5b is moved into the position C. Then, the charging, exposing, and developing processes for forming a monochromatic image of the magenta (M) color, that is, another color component of the original full-color image, on the peripheral surface of the drum 1 are carried out. Then, the thus formed magenta (M) toner image is transferred (first transfer) onto the belt 61, in the first transfer nip B, in such a manner that it is layered onto the yellow toner image, in alignment with the yellow toner image on the belt 61. After the first transfer of the magenta (M) toner image onto the belt 61, the rotary 50 is rotated 90° in the clockwise direction, whereby the third developing device 5c is moved into the position C. Then, the charging, exposing, and developing processes for forming a monochromatic image of the cyan (C) color, that is, another color component of the original full-color image, on the peripheral surface of the drum 1 are carried out. Then, the thus formed cyan (C) toner image is transferred (first transfer) onto the belt 61, in the first transfer nip B, in such a manner that it is layered onto the aligned combination of the yellow and magenta toner images on the belt 61, in alignment with the combination. After the first transfer of the cyan (C) toner image onto the belt 61, the rotary 50 is rotated 90° in the clockwise direction, whereby the third developing device 5d is moved into the position C. Then, the charging, exposing, and developing processes for forming a monochromatic image of the black (Bk) color, that is, another color component of the original full-color image, on the peripheral surface of the drum 1 are carried out. Then, the thus formed black (Bk) toner image is transferred (first transfer) onto the belt 61, in the first transfer nip B, in such a manner that it is layered onto the aligned combination of the yellow, magenta, and cyan toner images on the belt 61, in alignment with the combination. As a result, an unfixed full-color toner image is synthetically effected on the belt 61, from the four monochromatic images of Y+M+C+Bk colors, one for one.

That is, the rotary 50 is rotated by the rotary driving means to move one of the developing devices 5 into the position C where the developing device 5 opposes the drum 1. Then, this developing device 5 is used to develop the electrostatic latent image on the drum 1 into a toner image. In the case of the image forming apparatus in this embodiment, this operational sequence is repeated multiple (four) times to form a full-color toner image on the outward surface of the belt 61. Incidentally, the order in which the four monochromatic images, different in color (Y, M, C, and Bk) are sequentially formed on the drum 1 does not need to be as described above, that is, Y+M+C+Bk. That is, it may be altered as necessary or desired. After the formation of an unfixed full-color toner image on the belt 61, the aforementioned second transfer roller 66 is moved into its first position, that is, the position in which the roller 66 is kept in contact with the belt 61, before the leading edge of the unfixed full-color toner image on the belt 61 is moved by the movement of the belt 61 to where the second transfer roller 66 is. Further, the belt cleaning means 67 also is moved to its first position, that is, the position in which the cleaning means 67 is kept in contact with the belt 61. Meanwhile, one of the sheets of recording medium P, which is the third recording image bearing means, in the recording medium feeding-and-conveying portion (unshown), is separated from the rest and conveyed into the main assembly of the image forming apparatus. Then, the sheet of recording medium P (which hereafter will be referred to simply as recording medium P) is introduced into the interface between the second transfer belt 66 and belt 61 by a registration roller unit (unshown) with a preset timing. To the second transfer roller 66, a second transfer bias, which is preset in potential level and is opposite (positive) in static electricity polarity to toner, is applied, whereby the unfixed full-color toner image, that is, unfixed image made up of the layered four monochromatic toner images, different in color, on the belt 61, is transferred together (second transfer) onto the recording medium P, as if it is peeled away from the belt 61, while the recording medium P is conveyed through the second transfer nip D while remaining pinched by the second transfer roller 66 and belt 61. Then, the recording medium P is separated from the belt 61, and introduced into the fixation unit 8. In the fixation unit 8, the recording medium P and the four unfixed monochromatic toner images (making up unfixed full-color toner image) thereon, are subjected to heat and pressure as they are conveyed through the fixation nip of the fixation unit 8. Consequently, the four monochromatic toner images become fixed (after being melted and mixed) to the recording medium P. Thereafter, the recording medium P is discharged from the fixation unit 8, and then, is discharged, as a completed full-color copy, into the delivery portion (unshown) of the image forming apparatus. After the separation of the recording medium P from the belt 61, the secondary transfer residual toner, that is, the toner remaining on the belt 61 after the second transfer, is removed by the belt cleaning means 67.

As soon as a job for outputting one copy, or a job for continuously outputting multiple copies ends, the controller 100 puts the image forming apparatus on standby, and waits for the inputting of the next image formation start signal. That is, it stops driving the drum 1, laser-based scanner unit 3, belt 61, etc.. Further it moves the second transfer roller 66 and belt cleaning means 67 to the positions one for one where they are kept inactive. When the image forming apparatus is in the monochromatic image formation mode, only the fourth developing device 5d, that is, the developing apparatus for forming a black monochromatic image is used for image formation. As soon as a job for outputting one copy in monochromatic image formation mode, or a job for continuously outputting multiple copies ends in the monochromatic image formation mode, the controller 100 puts the image forming apparatus on standby, and waits for the inputting of the next image formation start signal.

### <Developing Device 5>

The first to fourth developing devices 5a, 5b, 5c, and 5d in this embodiment are the same in structure, although they are different in the color of the developer (toner) contained therein. FIG. 1(b) is an enlarged schematic sectional view of one of the developing devices in this embodiment. The developing device 5 has: a developer container 21 in which toner T is held; a development roller 25 which is a developer bearing member for bearing the developer for developing an electrostatic latent image on the drum 1; and a development roller coating member 24 which is a member for supplying the development roller 25 with toner by being virtually in contact with the development roller 25. The developing device 5 has also: a regulation blade which is a member for forming the body of the toner borne on the development roller 25 into a toner layer which is preset in thickness; and a seal 26 for preventing the toner from leaking out through the gap between the development roller 25 and developer container 21. The developer container 21 is a long and narrow container, and is positioned so that its lengthwise direction is parallel to the axial direction of the drum 1. Its downwardly facing wall has a long and narrow opening, which faces the drum 1, and the lengthwise direction of which is parallel to the axial line of the drum 1. The development roller 25 is positioned so that its peripheral surface faces this opening, and also, so that it is parallel to the lengthwise direction of the developer container 21. It is rotatably supported by the developer container 21. More specifically, the lengthwise end walls of the developer container 21 are provided with a pair of bearings (unshown), and the development roller 25 is rotatably supported by the pair of bearings. The development roller 25 in this embodiment is 13 mm in diameter. It comprises: an electrically conductive metallic core 28, which is 8 mm in diameter; a base layer 28a which is made of silicon rubber and covers the entirety of the peripheral surface of the metallic core 28; and a surface layer 28b which is made of acrylic urethane rubber and covers the entirety of the outer surface of the base layer 28a. The development roller 25 is 10⁴-10¹² Ω·cm in volume resistivity. The development roller coating roller 24 comprises: an electrically conductive metallic core 29, which is 6 mm in diameter; and a urethane sponge layer 29a, whose cells are interconnected, and which covers the entirety of the peripheral surface of the metallic core 29. It is a urethane sponge roller with a diameter of 15 mm, and is 10⁴-10¹² Ω·cm in volume resistivity. That is, the development roller coating roller 24 comprises a sponge layer whose cells are interconnected. Incidentally, although, in this embodiment, a roller having interconnected cells is used as the development sleeve coating roller 24, any roller may be used as the development roller coating roller 24, as long as the roller is structured so that toner is allowed to penetrate into the roller. For example, it may be a roller comprising a foamed layer having independent cells as long as it is structured so that toner is allowed to penetrate into the roller. An elastic layer formed of a substance having interconnected cells is greater in the amount by which it can internally hold toner than an elastic layer formed of independent cells. Therefore, a development roller coating roller having interconnected cells cell, is better suited for measuring the amount of the “electrostatic capacity”, which will be described later. The distance between the rotational axis 28 of the development roller 25 and the rotational axis 29 of the development sleeve coating member 24 is 13 mm. Thus, it appears as if the urethane sponge roller 29a of the development sleeve coating member 24 had penetrated into the development roller 25 by 1.0 mm. The regulation blade 27 is positioned so that as the development roller 25 is rotated, its opposite edge from the edge by which it is anchored, is placed virtually in contact with the peripheral surface of the development roller 25 and forms the body of the toner on the peripheral surface of the development roller 25 into a thin and uniform layer of the toner. It is a flexible member made of copper phosphate, urethane rubber, etc. The regulation blade 27 is solidly attached to the developer container 21, with one of its long edge portions attached to the top edge portion of the aforementioned opening of the container 21. The leak prevention seal 26 is a flexible member and is attached to the container 21 by one of its long edge portions. The other long edge is in contact with the development roller 25, one the bottom side of the container 21, covering thereby the gap between the development roller 25 and container 21 to prevent the toner in the developer container 21 from leaking out through the gap. The seal 26 is attached to the bottom edge of the aforementioned opening of the container 21.

As for the development of an electrostatic latent image formed on the drum 1 by the developing device 5, first, the developing device 5 is moved by the rotation of the rotary 50 by the angle necessary to move the developing device 5 into the position C (first position) where it faces the drum 1 as shown in FIGS. 1(a) and 1(b). In this embodiment, the main assembly of the image forming apparatus is structured so that as the developing device 5 is moved into the position C, it becomes upright (first attitude) in which the opposite side of the developer container 21 from the side having the aforementioned opening faces upward, whereas the side having the opening faces downward, and development roller 25 comes into contact with the drum 1. While the electrostatic latent image is developed by the developing device 5, the development roller 25 remains in contact with the drum 1. That is, the developing method used in this embodiment is the developing method of the so-called contact type. When the developing device 5 is in the position C, the mechanical force for driving the developing device 5 and development bias are inputted into the developing device 5 from the mechanical driving means (unshown) and electric power source E, respectively, of the main assembly of the image forming apparatus during image formation. Referring to FIG. 1(b), the development roller 25 is rotated at a preset speed in the clockwise direction, that is, the direction indicated by an arrow mark R4. Thus, the direction in which the peripheral surface of the development roller 25 moves in the interface between the development roller 25 and drum 1 is the same as the rotational direction R1 of the drum 1. Further, the development roller coating roller 24, which supplies the development roller 25 with toner by being in contact with the development roller 25, is rotated at a preset speed in the clockwise direction, that is, the direction indicated by an arrow mark R5. Thus, the direction in which the peripheral surface of the developer roller coating roller 24 moves in the interface between the roller 24 and development roller 25 is opposite (counter) to the rotational direction R4 of the development roller 25. As the development roller coating roller 24 and development roller 25 rotate, the peripheral surface of the development roller 25 is coated with toner by the development roller coating roller 24. Then, the body of the coated toner on the peripheral surface of the development roller 25 is formed into a thin layer by the regulation blade 27. Then, this thin layer of toner is moved to the development position C by the subsequent rotation of the development roller 25 to be applied to the peripheral surface of the drum 1. Further, a preset development bias, which in this embodiment is a DC voltage, is applied to the development roller 25 from a development bias application power source V, whereby the toner particles in the thin layer of toner on the peripheral surface of the development roller 25 transfer onto the specific points (points with low potential) of the electrostatic latent image on the peripheral surface of the drum 1. In other words, the electrostatic latent image is developed into a visible image (image formed of toner). The toner particles which were not used for the development of the electrostatic latent image are conveyed back into the developer container 21 by the subsequent rotation of the development roller 25, and are removed from the peripheral surface of the development roller 25 by the development roller coating roller 24. As the toner particles are removed from the peripheral surface of the development roller 25, the portion of the peripheral surface of the development roller 25, from which the toner particles have just been removed, is coated again with the toner in the developer container 21, by the development roller coating roller 24. The above described sequence is repeated to develop the electrostatic latent image on the peripheral surface of the drum 1.

When the developing device 5 is in the position C, its attitude is upright (first attitude) as described above. Thus, the toner T in the developer container 21 is kept in the bottom side of the developer container 21, that is, the side where the development roller coating roller 24 is present, by gravity. Designated by a referential code Ta is the top surface of the body of the toner T (developer) in the developer container 21. It is when the developing device 5 is in this attitude (upright) that the development roller coating roller 24 can be supplied with the toner T so that the development roller 25 can be coated with the toner T by the development roller coating roller 24. That is, it is when the developing device 5 is in this attitude (upright) that the toner T is in an area X, which is the top adjacencies of the nip between the developer bearing member (development roller 25) and developer supplying member (development roller coating roller 24), and therefore, the developing device 5 is capable of developing the electrostatic latent image on the peripheral surface of the drum 1. When the image forming apparatus is in an ordinary image forming operation, the developing device 5 is upright in the position C, that is, the development position, and the toner T in the developer container 21 is only on the bottom side of the developer container 21 because of the presence of gravity, which makes the area X and its adjacencies relatively high in toner density. This condition is ideal for image formation for the following reason. That is, if the area X and its adjacencies reduce in toner density during an ordinary toner image forming operation, it becomes impossible for the development roller 25 to be supplied with a sufficient amount of toner, sometimes causing thereby the image forming apparatus to output images having white spots or the like. This is why the area X and its adjacencies are desired to be high in toner density. When the developing device 5 is in the position F, its attitude is horizontal, and the development roller side of the developer container 25 is on the bottom side. When the developing device 5 is in the position E, its attitude is the upside-down attitude (second position), that is, the reverse attitude relative to the attitude in which the developing device 5 is in the position C. Further, when the developing device 5 is in the position G, it is in such a horizontal attitude that the development roller side of the developing device 5 faces upward.

### <Method for Detecting (Estimating) Remaining Amount of Toner in Developing Device>

As the first to fourth developing devices 5 (5a, 5b, 5c, and 5d) are used for image formation, the toner in each developing device 5 is consumed. Thus, the image forming apparatus is provided with a toner remainder amount detecting apparatus 100a (toner remainder amount detection circuit) for detecting the amount of toner remainder in each of the developing devices 5. As the amount of toner detected by the toner remainder amount detecting apparatus 100a falls to a threshold value preset for predicting the remaining length of the service left of a developing device 5, or warning a user of an imminent ending of the service life of a developing device 5, the controller 100 causes the display portion 300a of the control panel 300 to display the predicted remaining length of the service life of the developing device 5, or the warning about the imminent ending of the service life of the developing device, prompting thereby a user to prepare a replacement developing device 5, or to replace the developing device 5 in order to ensure that the image forming apparatus will remain at a preset level in terms of image quality. The old developing device (developing device in image forming apparatus) is replaced with a new developing device (replacement developing device) through the following preset procedural sequence, in which a developing device 5 having run out of toner (developer) is removed from the development device chamber of the rotary 50 through the preset developing device removal sequence, and a replacement developing device (new developing device, which is identical to removed one) is mounted into the emptied developing device chamber through the preset procedural sequence for mounting a developing device. In this embodiment, the amount of the toner remaining in a given developing device is detected when the developing device is in the second attitude (FIG. 1(a)); a developing device 5 which is in the position in which it is in the first attitude (FIG. 1(b)) is moved to the position in which it is in the second attitude (FIG. 1(a)). The first attitude of the developing device 5 is the attitude in which the developing device 5 can develop the electrostatic latent image on the drum 1, that is, the attitude in which the development roller coating roller 24 can be coated with the toner T. The second attitude of the developing device 5 is the attitude into which the developing device 5 is changed in attitude from the first attitude, and in which the toner on the development roller coating roller 24 returns to the developer container 21. The first attitude of the developing device 5 in this embodiment is the attitude in which the developing device 5 is in the position C (first position). The second attitude of the developing device 5 in this embodiment is the attitude in which the developing device 5 is in the position E (second position). As for the method for detecting the amount of toner remaining in the developing device 5 after the developing device 5 is changed in attitude into the second attitude, an AC bias is applied to the electrically conductive metallic core 29 of the development roller coating roller 24 (which functions as first electrode) by the toner (developer) remainder amount detecting apparatus 100a. Then, the amount of toner remaining in the developer container 21 is detected (estimated) by calculating the amount of the electrostatic capacity from the electrical voltage induced in the electrically conductive metallic core 28 (second electrode) of the development roller 25. Hereafter, “electrostatic capacity” means the electrostatic capacity between the development roller coating roller 24 and development roller 25. More concretely, the electrostatic capacity between the metallic core 28 of the development roller 25 and the metallic core 29 of the development roller coating roller 24 is measured. Further, in terms of the calculation of the amount of the “electrostatic capacity”, it is not always necessary to calculate the electrostatic capacity itself, such as 100 pf. That is, the amount of the toner remaining in the developing device 5 may be obtained by measuring the amount of voltage induced in the metallic core in response to the change in the amount of the electrostatic capacity, in the form of the voltage value or current value.

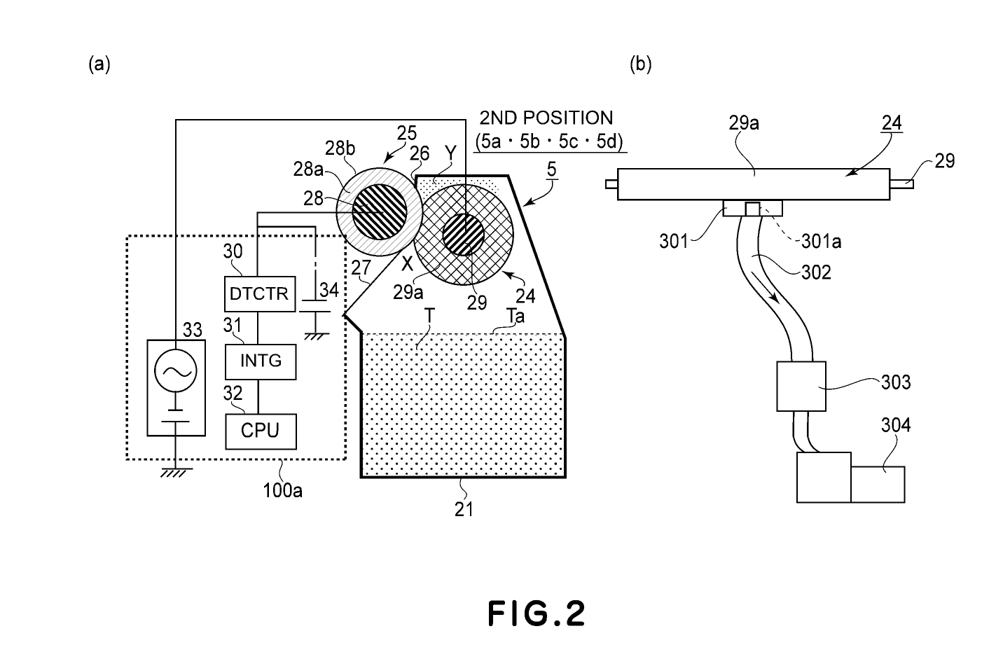

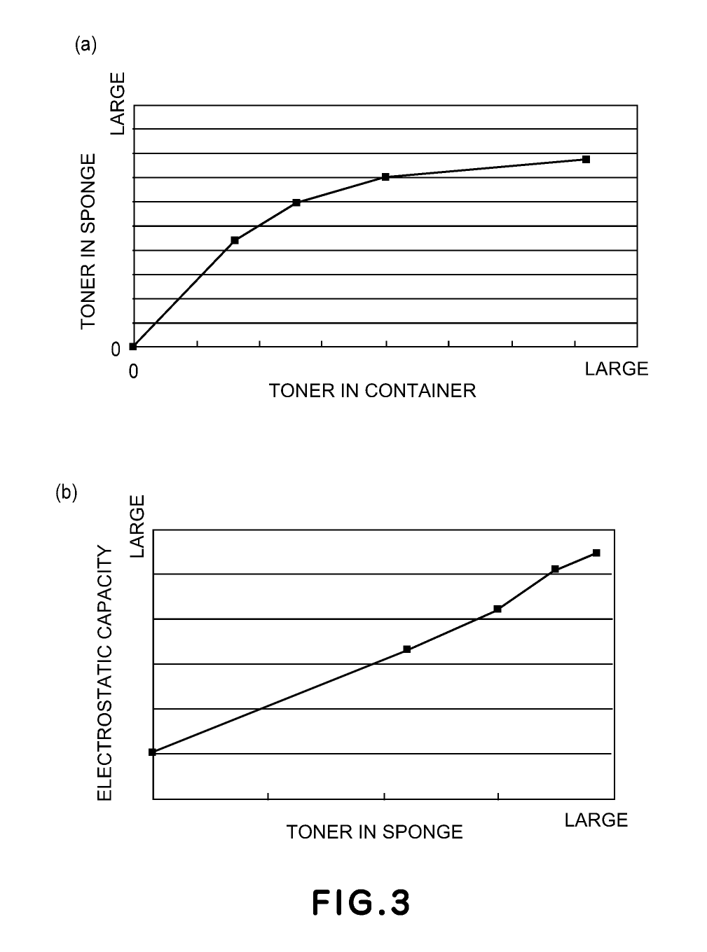

Next, the principle based on which the amount of the toner remaining in the developing device 5 is detected (estimated) will be described. One of the distinctive properties of the development roller coating roller 24 (which hereafter will be referred to simply as coating roller 24) in this embodiment is that it changes in the amount by which toner can be retained in the urethane sponge layer 29a, the cells of which are interconnected, is affected by the optimization of the airflow amount, which is one of the physical properties of the sponge layer 29a. The airflow amount indicates the amount by which air flows between the opening, at the peripheral surface of the urethane layer, of given cell, and the inward of the cell, per unit length of time. That is, the airflow amount is likely to reduce as the surface cells and internal cells are reduced in size, and therefore, increase in density. On the other hand, the amount of airflow is likely to increase as the surface and internal cells are increased in size. Thus, the amount by which toner can be retained in the sponge layer is affected by the change in the amount of airflow. Next, the method for measuring the amount of the airflow through the developer roller coating roller 24 will be described. Referring to FIG. 2(b) which is a schematic drawing for describing the method for measuring the amount of the airflow through the developer roller coating roller 24, a piece of acrylic plate 301 having a hole 301a, which is 10 mm in diameter, is placed in contact with the urethane sponge layer 29a of the coating roller 24 in such a manner that the hole 301a faces the sponge layer 29a. Then, a hose 302, which is larger in internal diameter than the hole 301a is connected to the hole 301a. Then, the amount of the airflow through the sponge layer 29a, hole 301a and hose 302 is measured with an airflow measuring device 303 (KZ type Air Permeability Tester: product of Daiei Kagaku Seiki). The capacity of the pump 304 is 10.8 liter/min without the coating roller 24. According to the experiments carried out by the inventors of the present invention, the amount of the airflow through the urethane sponge layer 29a (cells of which are interconnected) of the coating roller 24 was desired to be no less than 2 liter/min. Shown in FIG. 3(a) are the changes which occurred to the relationship between the amount of the toner in the sponge layer 29a of the coating roller 24 and the amount of the toner in the developing device 5 when the urethane layer 29a was optimized in the amount of airflow. Referring to FIG. 3(a), as the amount of the toner in the developer container 21 reduced, the amount of the toner in the sponge layer 29a of the coating roller 24 also reduced. It is evident from this result that there is a correlation between the amount by which toner is retained in the sponge layer 29a of the coating roller 24 and the total amount of the toner in the developer container 21. Further, the changes in the relationship between the amount of the toner in the sponge layer 29a of the coating roller 24 and the amount of the electrostatic capacity between the coating roller 24 and development roller 25 were measured. The results of the measurement is shown in FIG. 3(b). The amount of the electrostatic capacity was measured by the LCR meter ZM2354 (product of NF, Co., Ltd). Referring to FIG. 3(b), the relationship between the amount of the toner in the sponge layer and the amount of the electrostatic capacity is virtually linear. It is evident from these results that there is a correlation between the amount by which toner can be retained in the sponge layer 26a of the coating roller 24 and the amount of the electrostatic capacity between the coating roller 24 and development roller 25. In other words, the amount of the toner in the developer container 21 can be estimated by measuring the amount of the electrostatic capacity between the coating roller 24 and the development roller 25.

In this embodiment, the amount of the toner in the developer container 21 is detected (estimated) by measuring the amount of electrostatic capacity between the coating roller 24 and development roller 25 of the developing device 5 after the developing device 5 is changed in attitude from the first attitude, that is, the attitude in which it is when it is in the first position, to the second attitude, that is, the attitude in which it is when it is in the second position. More concretely, the image forming apparatus is provided with a developing device positioning unit which changes the developing device 5 in position from the first attitude (position) C in which toner can be supplied from the toner storage chamber of the developing device 5, which primarily stores toner, into the development chamber, that is, the chamber in which the coating roller 24 and development roller 25 are present, to the second attitude (position) E in which toner returns from the development chamber to the toner storage chamber. The amount of the toner remaining in the developing device 5 is detected while the developing device 5 is kept in the second attitude. Therefore, the amount of the electrostatic capacity is not affected by the change in the toner density, and the environment in which the developing device (image forming apparatus) is used, or left unused. Thus, the amount of the toner remaining in the developer container 21 can be precisely and reliably detected (estimated) by using the changes in the amount of the electrostatic capacity.

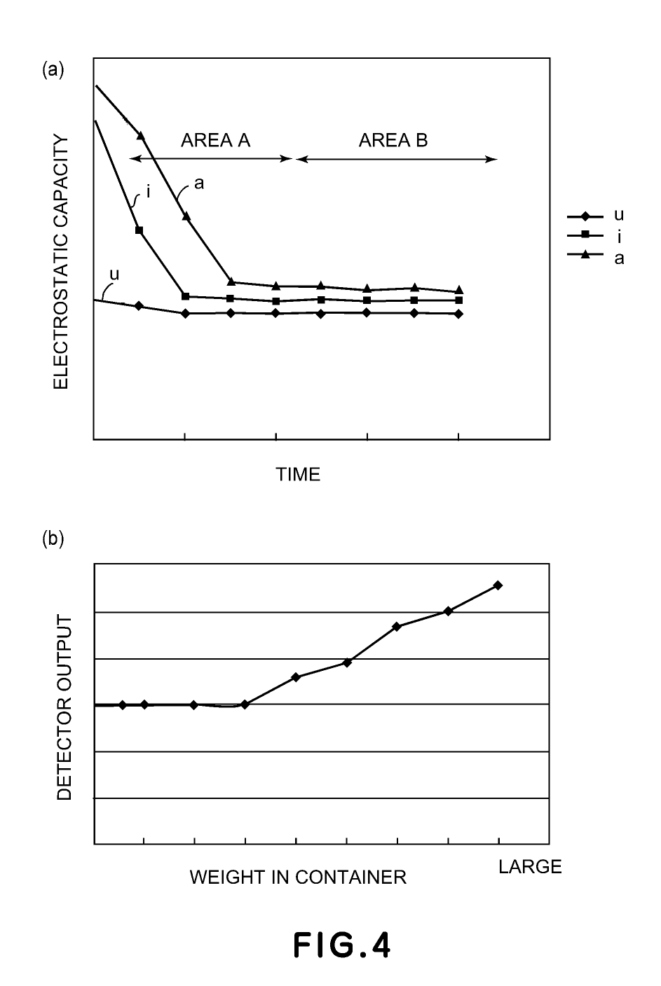

According to the above-described toner remainder amount detecting method, the measurement of the amount of the electrostatic capacity between the coating roller 24 and development roller 25 is started immediately after the developing device 5 is moved into the second position E, and the changes which occur to the amount of the electrostatic capacity during a preset length of time is mathematically calculated. It is based on the thus obtained value that the amount of the toner in the developer storage chamber 21 is obtained by calculation. Next, these steps for estimating the amount of the toner remaining in the developer container 21 are described in more detail. First, the behavior of the toner T in the developer container 21 of the developing device 5 will be described. The attitude of the developing device 5 in the position C (development position) is upright. Thus, the toner T in the developer container 21 is kept in only the bottom side of the developer container 2 by gravity. Therefore, a large amount of toner is in the area X, that is, the area in the top adjacencies of the nip between the development roller 25 and coating roller 24 in terms of gravity direction. In this embodiment, it is in the area X, which is on the upstream side of the nip between the coating roller 24 and development roller 25 in terms of the rotational direction of the development roller 25 that a large amount of toner is present. As the rotary 50 rotates 90°, the developing device 5 changes in position from the position C to the position F, and then, as the rotary 50 further rotates by additional 90°, the developing device 5 changes in position from the position F to the position E (which is 180° away from position C). When the developing device 5 is in the position E, the attitude of the developing device 5 is upside-down, and therefore, the portion of the body of the toner T, which was in the area X, falls from the area X due to the presence of gravity. That is, the attitude of the developing apparatus in the second position is the position in which the developer which is on the nip and its adjacencies when the developing apparatus is in the first position falls. Eventually, there will be no toner in the adjacencies of the coating roller 24 as shown in FIG. 2(a). Therefore, the amount of electrostatic capacity between the metallic core 28 of the development roller 25 and the metallic core 29 of the developer supply roller 24 when the developing device 5 is in the position C is different from that when the developing device 5 is in the position E. In this embodiment, the position C shown in FIG. 1(a) is the first position, and the position E shown in FIG. 1(a) is the second position. It is when the developing device 5 is in the position E that the amount of the toner remaining in the developing device 5 is detected by the toner remainder amount detecting apparatus 100a. The toner remainder amount detecting apparatus 100a is the “detecting apparatus for detecting the amount of the developer remaining in the developer storage chamber of the developing device 5, based on the changes in the amount of the electrostatic capacity between the first and second electrodes, which occurs during a preset length of time immediately after the developing apparatus is moved from the first position to the second position by the developing device positioning unit”. The results of the operation in which the amount of the electrostatic capacity began to be detected by the toner remainder amount detecting apparatus 100a immediately after the movement of the developing device 5 into the position E are shown in FIG. 4(a). For example, in a case where the amount of the toner T in the developer container 21 is relatively large, such as immediately after the developing device 5 began to be used for the first time, the output of the toner remainder amount detecting apparatus 100a changes, as indicated by a line “a” in FIG. 4(a), immediately after the movement of the developing device 5 into the position E. That is, the amount of the electrostatic capacity detected by the toner remainder amount detecting apparatus 100a during a period A in FIG. 4(a) is greater than that when the amount of the toner in the adjacencies of the metallic core 29 of the coating roller 24 is only the toner in the sponge layer of the coating roller 24. This phenomenon occurs because not all toner particles fall from the coating roller 24 immediately after the movement of the developing device 5 into the position E, and therefore, there is a certain amount of toner still remaining on the coating roller 24. Thus, the amount of the electrostatic capacity detected during the period A is greater than the amount of the electrostatic capacity, which corresponds to only the amount of the toner in the sponge layer of the coating roller 24. Thus, as the toner T continuously falls because of the presence of by gravity, the output (detected amount of electrostatic capacity) of the toner remainder amount detecting apparatus 100a gradually reduces. Eventually, no toner will remain in the adjacencies of the coating roller 24, and the top surface Ta of the body of the toner T in the developer container 21 falls below the coating roller 24, as shown in FIG. 2(a). Thus, the output stabilizes. Referring to FIG. 4(a), a period B is when the output of the toner remainder amount detecting apparatus 100a is stable. In comparison, in a case where the service life of the developing device 5 has been reduced to roughly half by its usage, the output of the toner remainder amount detecting apparatus 100a changes as indicated by the line “i” in FIG. 4(a). That is, the period A is shorter because the toner T in the developer container 21 has been substantially consumed. Therefore, the state in which no toner is in the adjacencies of the coating roller 24, that is, the state in which the surface Ta of the body of the toner T in the developer container 21 is below the coating roller 24, occurs sooner. Further, toward the end of the service life of the developing device 5, the changes in the output of the toner remainder amount detecting apparatus 100 becomes as indicated by line “u”. In this case, there is already not much toner in the adjacencies of the coating roller 24, and the surface Ta of the body of the toner T is below the coating roller 24. Therefore, the output of the toner remainder amount detecting apparatus 100a is not as high as that detected in the period A. Therefore, the output of the toner remainder amount detecting apparatus 100a becomes stable as soon as the developing device 5 is moved into the position E.

In this embodiment, the output of the toner remainder amount detecting apparatus 100a is mathematically processed as follows, in consideration of the above described behavior of the toner T and the resultant changes in the output value of the toner remainder mount detecting apparatus 100a: 1) the outputs of the apparatus 100a during the period B, which correspond to the amount of the toner in the sponge layer of the coating roller 24, is averaged to obtain a toner remainder amount detection output R, which is used as a background value. 2) the value T obtained by the surface integration of the difference which will be described below, with respect to the length of time the amount of the electrostatic capacity was detected by the toner remainder amount detecting apparatus 100a is the toner remainder amount detection output R. The abovementioned difference is the value obtained by subtracting the background value from the value of the amount of the electrostatic capacity measured by the apparatus 100a during the period A. Therefore, it reflects the amount of the toner particles which failed to fall from the coating roller 24, being therefore greater than the amount of the electrostatic capacity which reflects the actual amount of the toner in the sponge layer. The toner remainder amount detection output R is measured after the attitude of the developing device 5 is changed to the upside-down, that is, the second attitude. In other words, the output R is measured when there is virtually no toner in the adjacencies of the coating roller 24. Therefore, it does not fluctuate; the amount of the electrostatic capacity does not fluctuate. Thus, it can be used to accurately estimate the amount of the toner in the sponge layer of the coating roller 24 the toner remainder amount detection output R does not reflects the above described changes in the amount of the electrostatic capacity. In other words, it can be used to accurately estimate the amount of the toner in the sponge layer of the coating roller 24. The amount of the toner in the sponge layer of the coating roller 24 tends to reduces as the amount of the toner in the developer container 21 reduces. However, in the area of the developer container 21, in which the amount of toner is relatively large, the ratio by which the amount of the toner in the sponge layer of the coating roller 24 reduces, relative to the amount by which the toner in the developer container 21 reduces, is relatively small. In other words, the toner remainder amount detecting apparatus 100a in this embodiment, which detects the changes in the amount of the electrostatic capacity between the coating roller 24 and development roller 25, is low in terms of the level of accuracy with which the amount of the toner remainder in the developer container 21 is detected. Thus, the toner remainder amount detection output T is obtained to improve the toner remainder amount detecting apparatus 100a in this embodiment, in the accuracy with which it detects the toner remainder amount in the developer container 21 when the amount of the toner in the developer container 21 is relatively large. The changes in the relationship between the toner remainder amount detection output T and the amount of the toner in the developer container 21 is shown in FIG. 4(b). It was discovered that until the amount of the toner in the developer container 21 falls to a certain value, the amount by which the toner remainder amount detection output T reduces is virtually proportional to the amount by which the amount of the toner in the developer container 21 reduces, as shown in FIG. 4(b). Thus, when the amount of the toner in the developer container 21 is relatively large, the correlation between the toner remainder amount detection output T and the total amount of the toner in the developer container 21 is used to estimated the amount of the toner remaining in the developer container 21. That is, the amount of the toner in the developer container 21 can be highly accurately detected (estimated) from when a brand-new developing device 5 is used for the first time to when its service life expires, by such mathematical calculation that complimentarily uses the toner remainder amount detection output R and toner remainder amount detection output T. In this embodiment, the correlation between the value obtained by the surface integration of the toner remainder amount detection output, with respect to the length of time the amount of the electrostatic capacity is measured is used to estimate the toner remainder amount in the developer container 21. However, the similar results can be obtained by subjecting the toner remainder amount detection output to a mathematical process that shows the correlation between the toner remainder amount detection output and the amount of the toner in the developer container 21, for example, the rate of the change in the amount of the electrostatic capacity, which is obtainable by the differentiation of the amount of the electrostatic capacity with respect to time (elapsed time). Next, the case in which the amount of the toner remainder in the developer container 21 is detected (estimated) by the differentiation of the amount of the electrostatic capacity with respect to time (elapsed time) will be described. As the amount of the toner in the developer container 21 further reduces, the amount of the electrostatic capacity changes from the amount represented by the line “a” in FIG. 4(a) to the amount represented by the line “u”. That is, as the amount of the toner in the developer container 21 reduces, the value obtained by the differentiation of the amount of the electrostatic capacity, with respect to the elapsed time (period A) becomes virtually zero. Therefore, it is possible to detect (estimate) the amount of the toner remainder in the developer container 21, based on the value obtained by differentiating the amount of the electrostatic capacity with respect to the elapsed time. That is, it is possible detect the amount of the toner remainder in the developer container 21 based on the value obtained by the differentiation of the amount of the electrostatic capacity with respect to the elapsed time. For example, if the value obtained by the differentiation of the amount of the electrostatic capacity with respect to the elapsed time exceeds a preset threshold value, it may be determined that the amount of the toner in the developer container 21 fell below a preset value. In this embodiment, the amount of the electrostatic capacity between the developer supplying member 24 and developer bearing member 25 begins to be measured immediately after the developing device 5 is moved into the second position E, and the amount of the developer in the developer container 21 is calculated (estimated) based on the value obtained by differentiating the measured amount of the electrostatic capacity, that is, the output of the toner remainder amount detecting apparatus 100a, with respect to the elapsed time.

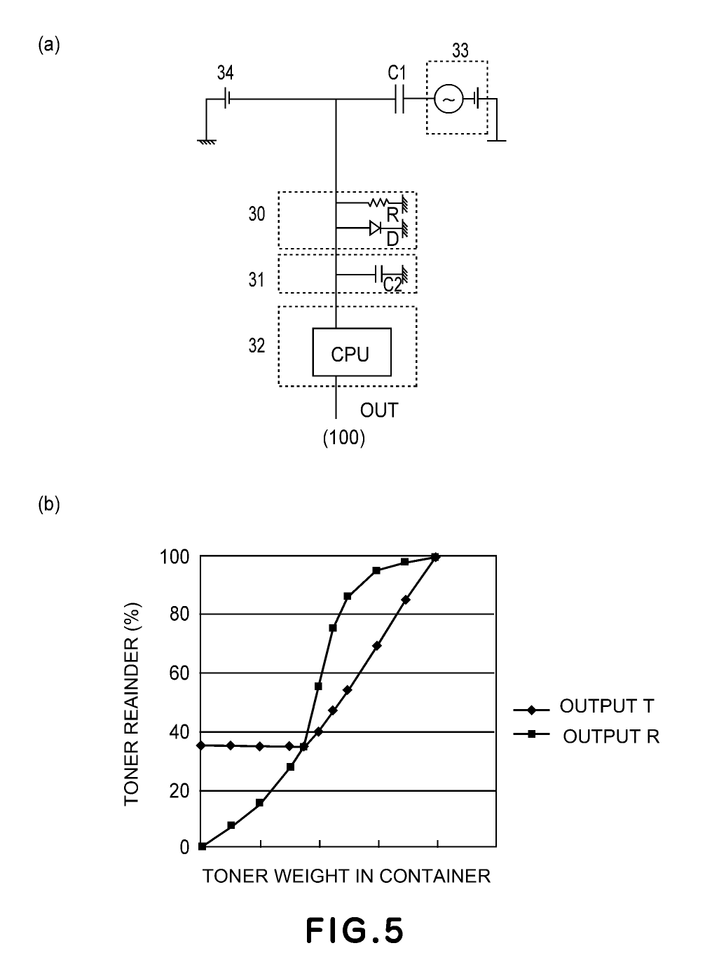

Next, a detecting device 30 and an integrating device 31 which make up the toner remainder amount detecting apparatus 100a is described. FIG. 5(a) is a schematic diagram which shows the equivalent circuits of the condenser C1 (which comprises coating roller 24 and development roller 25), detecting device 30, integrating device 31, electric power source 33 for toner remainder amount detection bias, electric power source 34 for development bias, etc. The toner remainder amount detection bias, which is an AC bias, is supplied from the electric power source 33 for the toner remainder amount detection. The detecting device 30 comprises a resistor R and a diode D. The output of the condenser C1 is picked up as the voltage of the resistor R, and is half-wave rectified. The half-wave rectified voltage is integrated by the integrating device 31, which is a condenser C2 in FIG. 4(a), becoming thereby a DC voltage. The detected voltage is subject to the above described mathematical process by the CPU 32, to obtain the toner remainder amount detection output R and toner remainder amount detection output T. In this embodiment, the application of the AC bias to the developing device 5 from the electric power source 33 for toner remainder amount detection bias, and the toner remainder amount detection by the detecting device 30, integrating device 31, and CPU 32, are started immediately after the movement of the developing device 5 from the position F to the position E. Next, referring to FIG. 5(b), the display of the amount of the toner remaining in the developing device 5 is described. The value displayed to show the amount of the toner in the developing device 5 immediately after a developing device 5 is used for the first time is obviously 100%. As an image forming operation continues, the amount of the toner T in the developer container 21 reduces, and therefore, the output T of the toner remainder amount detecting apparatus 100a reduces as described above, reducing thereby the value displayed to show the amount (percentage) of the toner remainder in the developer container 21. In this embodiment, as the actual amount of the toner in the developer container 21 falls to roughly 40%, the output T of the toner remainder amount detecting apparatus 100a falls to virtually zero. That is, as the actual amount of the toner in the developer container 21 falls to roughly 40%, no toner remains in the adjacencies of the coating roller 24, that is, the surface Ta of the body of the toner T in the developer container 21 falls below the coating roller 24. From this point on, the estimated amount (percentage) of the toner in the developer container 21 is displayed based on the toner remainder amount detection output R. Then, as the output T falls to a preset value, “0%” is displayed as a warning on the display portion 300a of the control panel 300 to inform a user that a specific developing device (5) is “running out of toner”, or that it is time for the replacement of the specific developing device (5). Incidentally, as the output T falls to a preset value, the on-going image forming operation may be interrupted, in addition to displaying “0%” or “running out of toner”. As described above, the image forming apparatus in this embodiment can accurately detect the amount of the toner remaining in the developer container 21, and convey to a user the information about the amount of the toner in the developer container 21. In this embodiment, the toner remainder amount detecting operation is started immediately after the transfer of the developing device 5 from the position F to the position E. However, it is not mandatory that the operation is started immediately after the transfer of the developing device 5 from the position F to the position E. That is, as long as the changes in the amount of the electrostatic capacity can be detected, the timing with which the toner remainder amount detecting operation is started may be slightly before or after the transfer of the developing device 5 into the position E.

### Embodiment 2

The image forming apparatus and developing devices in this embodiment are practically the same in structure as those in the first embodiment, except that those in this embodiment are provided with an antenna dedicated to the detection of the toner remainder amount detection output T. The effects of this embodiment are the same as the above-described effects of the first embodiment.

### <Developing Device>

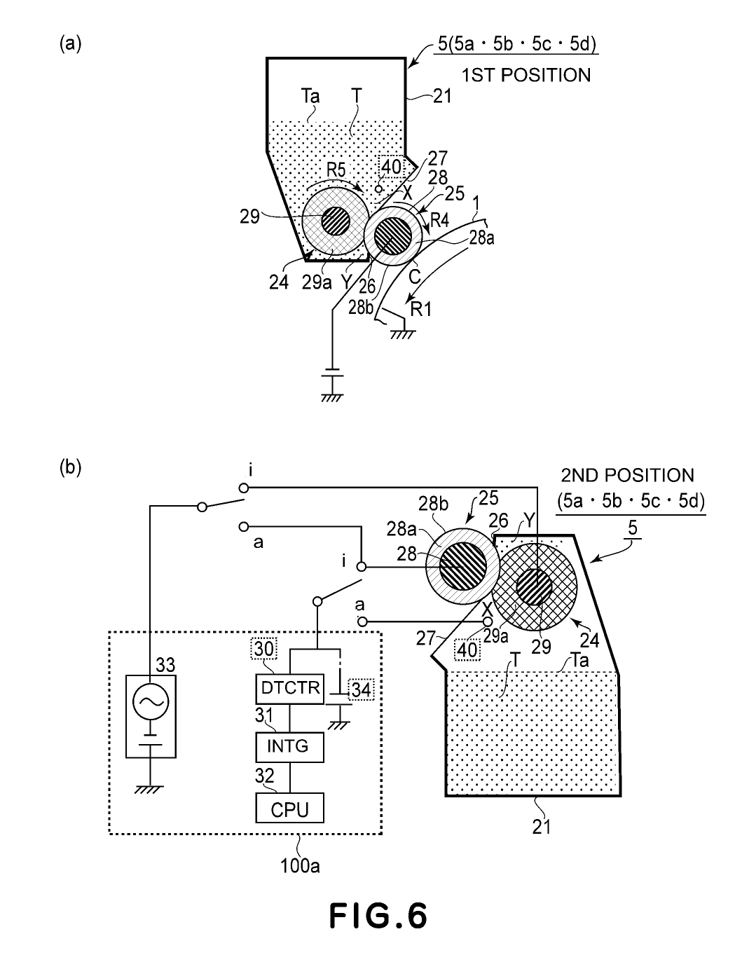

The first to fourth developing devices 5a, 5b, 5c, and 5d in this embodiment are the same in structure although they are different in the color of the developer (toner) contained therein. Further, they are the same in structure as those in the first embodiment. Thus, the components, portions, etc., of the image forming apparatus in this embodiment, which are the same as the counterparts in the first embodiment are given the same referential codes, and are not described. FIG. 6(b) is an enlarged schematic sectional view of one of the developing devices 5 in this embodiment, which is in the position C. The developing device 5 has: a developer container 21, which is a developer storage chamber for storing toner T; a development roller 25 which is a developer bearing member for bearing the developer for developing an electrostatic latent image on the drum 1; and a development roller coating member 24 which is a member for supplying the development roller 25 with toner by being virtually in contact with the development roller 25. The developing device has also: a regulation blade which is a member for forming the body of the toner borne on the development roller 25, into a toner layer which is preset in thickness; and a seal 26 for preventing the toner in the developer container 21 from leaking out through the gap between the development roller 25 and developer container 21. Further, the developing device has an antenna 40 (first electrode), which is in the adjacencies of the development roller coating roller 24 which is the developer supplying member for supplying the development roller 25 with toner by being placed in contact with the development roller 25. The antenna 40 is positioned so that it extends in the lengthwise direction of the developer container 21, through the area X, which will be described later.

### <Method for Detecting Amount of Toner Remaining in Developer Container Using Antenna>

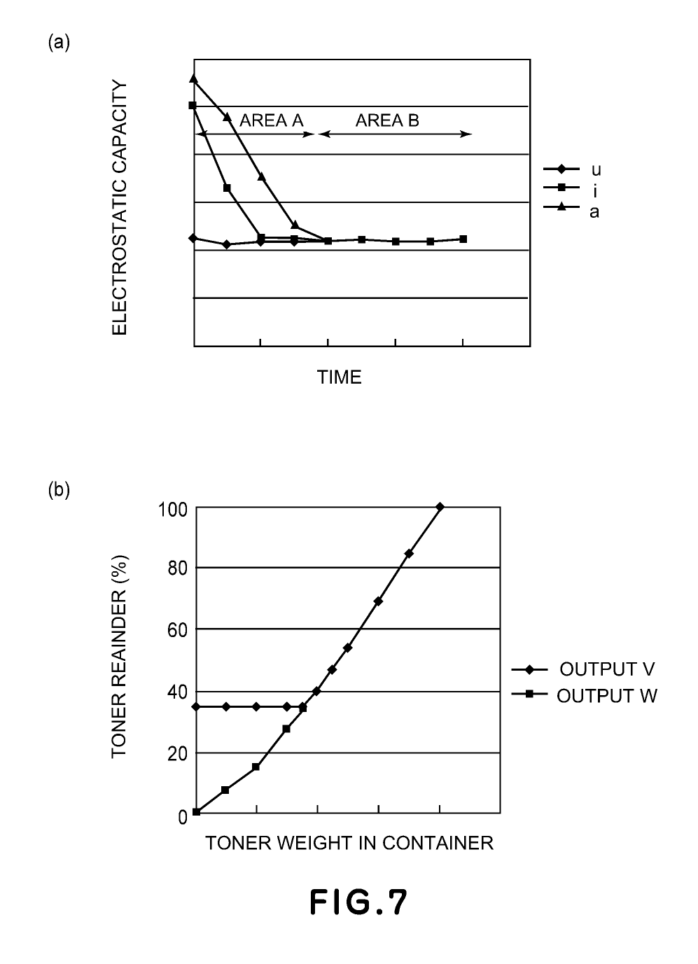

The image forming apparatus and developing devices in this embodiment are virtually the same in structure as those in the above described first embodiment, except that the developing devices in this embodiment have the antenna 40 dedicated to the detection of the toner remainder amount detection output T. The toner remainder amount detecting method described in regard to the description of the first embodiment can also be used by the image forming apparatus and developing devices in this embodiment. In addition, in the case of this embodiment, the toner remainder amount can be detected with the use of the antenna. The operation for detecting the amount of the toner remaining in the developing device 5 with the use of the antenna is also carried out after the developing device 5 is changed in attitude from the first attitude (FIG. 6(a)) into the second attitude (FIG. 6(b)). Also in this embodiment, the first attitude of the developing device 5 is the attitude in the developing device 5 is when it is in the position C. The second attitude is the attitude in which the developing device 5 is in the position E (second position). The toner remainder amount detecting method which uses the antenna 40 is as follows: an AC bias is applied to the electrically conductive metallic core 28 of the development roller 25 by the toner remainder amount detecting apparatus 100a. Then, the amount of the toner remaining in the developer container 21 is detected (estimated) from the amounts of voltage and electrostatic capacity induced in the antenna 40 (which is electrically conductive). Hereafter, the output of the toner remainder amount detecting apparatus 100a which detects the amount of the electrostatic capacity through the antenna 40 is referred to as the electrostatic capacity detection output S. The above described operation for detecting the amount of the electrostatic capacity, that is, the operation which detects the amount of the electrostatic capacity between the development roller 25 and antenna 40 is started immediately after the developing device 5 is transferred to the second position E, and the changes which occurs to the electrostatic capacity detection output S during a preset length of time (detection time) is subjected to mathematically process, with respect to the preset length of time. Next, the method for calculating (estimating) the amount of the developer in the developer storage chamber 21 is described in detail. First, the behavior of the toner T in the developer container 21 is described. When the developing device 5 is in the position C, that is, the development position, its attitude is upright. Thus, the toner T in the developer container 21 is kept in only the bottom side of the developer container 21 2 by gravity. Therefore, a large amount of toner is in the area X, that is, the top adjacencies of the nip between the development roller 25 and coating roller 24 in terms of gravity direction. In this embodiment, it is in the area X, which is on the upstream side of the nip between the coating roller 24 and development roller 25 in terms of the rotational direction of the development roller 25 that a large amount of toner is present. The antenna 40 is positioned so that it extends in the lengthwise direction of the developing device 5 through the area X. As the rotary 50 rotates 90°, the developing device 5 changes in position from the position C to the position F, and then, as the rotary 50 further rotates by additional 90°, the developing device 5 changes in position from the position F to the position E (which is 180° away from position C). When the developing device 5 is in the position E, the attitude of the developing device 5 is upside-down, and therefore, the portion of the body of the toner T, which was in the area X, is made to fall away from the coating roller 24 by gravity. Eventually, there will be no toner in the adjacencies of the antenna 40 as shown in FIG. 6(b). In this embodiment, the position C shown in FIG. 6(a) is referred to as the first position, and the position E shown in FIG. 1(a) is referred to as the second position. It is when the developing device 5 is in the position E that the amount of the toner remaining in the developing device 5 is detected by the toner remainder amount detecting apparatus 100a. The results of the operation in which the amount of the electrostatic capacity began to be detected by the toner remainder amount detecting apparatus 100a immediately after the movement of the developing device 5 into the position E are shown in FIG. 7(a). For example, when the amount of toner T in the developer container 21 is relatively large, such as immediately after the developing device 5 began to be used for the first time, the electrostatic capacity detection output S changes as indicated by a line “a”, immediately after the movement of the developing device 5 into the position E. That is, the output S is greater in value during a preset length of time within the period A, where a substantial amount of toner, which did not fall immediately after the movement of the developing device 5 into the position E, is still in the adjacencies of the antenna 40. Thus, as the portion of the toner T, which remained in the adjacencies of the antenna 40, continues to fall away from the coating roller 24, the electrostatic capacity detection output S gradually reduces. Eventually, no toner will remain in the adjacencies of the antenna 40. Thus, the output S stabilizes. Referring to FIG. 7(a), a period B is the period in which the electrostatic capacity detection output S is stable. In comparison, when the service life of the developing device 5 has been reduced to roughly half by its usage, the electrostatic capacity detection output S changes as indicated by the line “i” in FIG. 7(a). That is, because the toner T in the developer container 21 has been substantially consumed, the period A is relatively short. Therefore, the state in which no toner is in the adjacencies of the antenna 40 comes sooner. Toward the end of the service life of the developing device 5, the electrostatic capacity detection output S becomes as indicated by line “u”. During this period in the service life of the developing device 5, there is not much toner left in the adjacencies of the antenna 40 anyway, and therefore, the output S is not going to be as high as that in the period A. Thus, the electrostatic capacity detection output S becomes stable in value immediately after the movement of the developing device 5 into the position E.

In this embodiment, the output of the toner remainder amount detecting apparatus 100a is mathematically processed as follows, in consideration of the above-described behavior of the toner T and the resultant changes in the electrostatic capacity detection output S. In the first place, the electrostatic capacity detection output S in the period B is such an output that is obtained when there is virtually no toner in the adjacencies of the antenna 40. Therefore, it is stable regardless of the state of the usage of the developing device, that is, the amount of the usage of the toner in the developer container 21. Thus, the outputs of the apparatus 100a during the period B are averaged to obtain a background value U. Then, the difference obtained by subtracting the background value U from the electrostatic capacity detection output S is surface-integrated, with respect to the length of time the amount of the electrostatic capacity is detected, to obtain a toner remainder amount detection output V. Since the toner T in the developer container 21 behaves as described above, the toner remainder amount detection output V reduces in proportion to the toner remainder amount in the developer container 21 as the amount of the toner in the developer container 21 gradually reduces to a preset value. The preset value is the value at which no toner will be in the adjacencies of the antenna 40. That is, the electrostatic capacity detection output S becomes stable, making stable the background value, and therefore, the toner remainder detection output V becomes a preset value, which is zero in this embodiment. As soon as the toner reminder amount detection output V becomes zero, the image forming apparatus starts the second toner remainder amount detecting apparatus. The first toner remainder amount detecting apparatus in this embodiment is the same as the above described toner remainder amount detecting apparatus in the first embodiment. The second toner remainder amount detecting apparatus applies an AC bias to the metallic core 29 of the coating roller 24 by the toner remainder amount detecting apparatus 100a. Then, it detects (estimates) the amount of the toner in the developer container 21 based on the amount of voltage and electrostatic capacity induced in the metallic core 28 (which is electrically conductive) of the development roller 25. The second toner remainder amount detecting apparatus outputs a toner remainder amount detection output W. The toner reminder amount detection output W is the output of the second toner remainder amount detection apparatus when the output of the toner remainder amount detection output V is zero, that is, when there is virtually no toner is in the adjacencies of the antenna 40. When the developing device 5 is in the second position, that is, when the developing device 5 is upside-down in attitude, there is no excess amount of toner in the adjacencies of the coating roller 24. Therefore, there is no change in the electrostatic capacity, making it possible to accurately estimate the amount of the toner in the sponge layer of the coating roller 24. As for the toner remainder amount detection output W, it is likely that as the amount of the toner in the developer container 21 reduces, the amount of the toner in the sponge layer of the coating roller 24 also reduces. The area of the developer container 21, which is relatively large in the amount of the toner, is smaller in the ratio between the rate with which the amount of the toner in the sponge layer of the coating roller 24 reduces, relative to the rate with which the amount of the toner in the developer container 21 reduces is small. That is, when the amount of the toner in the developer container 21 is relatively large, the accuracy with which the amount of the toner in the developer container 21 is detectable is relatively low. Thus, in this embodiment, the developing device 5 is provided with an electrically conductive antenna to obtain the electrostatic amount detection output S, in order to improve the image forming apparatus in terms of the accuracy with which the amount of the toner in the developer container 21 is detected when the amount of the toner in the developer container 21 is relatively large.

Referring to FIG. 7(b), the portion of the developer container 21, which is large in the amount of the toner, is smaller in the ratio of the rate with which the toner in the sponge layer of the coating roller 24 reduces, relative to the rate with which the toner in the developer container 21 reduces, and therefore, is lower in the accuracy with which the amount of the toner remainder in the developer container 21 can be detected. Therefore, when the amount of the toner in the developer container 21 is relatively large, the amount of the toner remainder in the developer container 21 is calculated (estimated) based on the decrease in the toner remainder amount detection output V. Then, as the amount of the toner remaining in the developer container 21 falls to a preset value (35% in this embodiment), that is, as the value of the toner remainder amount detection output V falls to zero, the amount of the toner remainder in the developer container 21 begins to be calculated based on the toner remainder amount detection output W, which is the ratio of the rate with which the amount of the toner in the sponge layer of the coating roller 24, relative to the ratio with which the amount of the toner remainder in the developer container 21 reduces. That is, the toner remainder amount detection output V and toner remainder amount detection output W are complimentarily used to mathematically estimate the amount of the toner remaining in the developer container 21. Therefore, the amount of the toner remaining in the developer container 21 can be highly precisely detected from when a given developing device begins to be used for the first time to when it runs out of the toner. In this embodiment, the correlation between the value obtained by surface-integrating the electrostatic capacity detection output, with respect to the length of the electrostatic capacity detection time, and the amount of the toner remainder in the developer container 21, is used to calculate (estimate) the amount of the toner remaining in the developer container 21. However, the same effects can also be obtained by a mathematical process which shows the relationship between the time-differentiation which shows the rate of change in the electrostatic capacity amount detection output, and the amount of the toner remainder in the developer container 21. That is, the amount of the electrostatic capacity between the antenna 40 (electrode) and developer bearing member 25 begins to be measured immediately after the movement of the developing device 5 into the second position E, and the amount of the developer in the developer storage chamber is calculated based on the value obtained by time-differentiating the electrostatic capacity detection output.

FIG. 6(b) shows the structure of the toner remainder amount detecting apparatus 100a in this embodiment. A toner remainder amount detection bias, which is an AC bias, is applied from the electric power source 33 for toner remainder amount detection bias. The image forming apparatus is structured so that the toner remainder amount detection bias can be selectively supplied to the metallic core (which is electrically conductive) of the development roller 25, or that of the coating roller 24. Further, the toner remainder amount detection circuit, which comprises a detecting device 30, etc., are selectively connectible to the antenna 40, or the electrically conductive metallic core of the development roller 25. Referring to FIG. 6(b), in this embodiment, the toner remainder amount detection bias is switchable to the development roller 25, and the toner remainder amount detection circuit is switchable to the antenna 40. Further, the toner remainder amount detection bias is switchable to the coating roller 24, and the toner remainder amount detection circuit is switchable to the development roller 25. The reason why these biases are made switchable is to make it possible for the toner remainder amount to be accurately detectable to the end of the service life of a given developing device. The antenna 40 is unlikely to retain toner. Thus, as the developing device 5 is changed in position to measure the amount of the electrostatic capacity between the development roller 25 and antenna 40 after the amount of the toner in the developing device 5 has become small, the toner which was in the adjacencies of the antenna before the position change immediately disappears, making it therefore difficult to detect the changes in the amount of the electrostatic capacity. In comparison, the coating roller 24 has the foamed layer, being therefore likely to retain a certain amount of toner. Thus, even after the substantial amount of reduction in the amount of the toner remainder in the developing device 5, the change in the amount of the electrostatic capacity between the development roller 25 and coating roller 24 is likely to be gentle even after the change in the position of the developing device 5, making it possible to measure the amount of the electrostatic capacity. As described above, the electrode for measuring the amount of the electrostatic capacity may be switched according to the amount of the toner remainder in the developing device 5. As for the reason for the switch, when the coating roller 24 is used as the electrode, there is the toner in the coating roller 24. Therefore, while the amount of the electrostatic capacity is measured within the period B shown in FIG. 4(a), the amount of the electrostatic capacity is changed by the amount of the toner remainder in the developer container 21. Although the amount of the electrostatic capacity measured during the period B is canceled as the background, there is a possibility that it will still affect the measurement accuracy. Thus, while the large amount of toner still remains in the developer container 21, the amount of the electrostatic capacity between the antenna 40 and development roller 25 is measured to make it unnecessary to take the background value into consideration (period B in FIG. 7(b)), so that the amount of the electrostatic capacity can be measure with a higher level of accuracy. If it is determined from the amount of the electrostatic capacity between the antenna 40 and development roller 25 that the amount of the toner in the developer container 21 fell below a preset value, the coating roller 24 begins to be used as the electrode for measuring the amount of the electrostatic capacity. Incidentally, if the amount of the developer in the developer container 21 can be detected at a satisfactory level of accuracy by measuring the amount of the electrostatic capacity between the development roller 25 and antenna 40 to the end of the service life of a developing device, the image forming apparatus does not need to be provided with the abovementioned switching means. The means, in this embodiment, for displaying the amount of the toner remaining in a given developing device is the same as the above described one in the first embodiment, and therefore, is not described here.

As described above, the present invention can make it possible for an image forming apparatus to accurately detect the amount of the toner remaining in a given developing device in the apparatus, and inform a user of the information (amount of toner remainder in developing device). In the above described embodiments of the present invention, the operation for detecting the toner remainder amount in the developer container 21 was started immediately after the developing device 5 was moved from the position F to the position E. However, it is not mandatory that the operation is started immediately after the movement of the developing device 5 into the position E. In other words, as long as the changes in the amount of the electrostatic capacity can be detected, the timing with which the operation is to be started may be slightly before or after the transfer of the developing device 5 into the position E. Incidentally, the image forming apparatus in the second embodiment was structured so that the amount of the electrostatic capacity between the antenna 40 and development roller 25 is measured. However, this setup is not mandatory. That is, as long as the amount of the electrostatic capacity is changed by the change in the position of the developing device 5, the apparatus may be structured so that the amount of the electrostatic capacity between the antenna 40 and coating roller 24 is measured. Further, instead of using the development roller 25 or coating roller 24 as one of the electrodes, two or more antennas may be provided to be used as electrodes for electrostatic capacity detection, so that the amount of the electrostatic capacity between two antennas is measured for the detection of the amount of the toner remainder in the developing device 5. Further, in consideration of the fact that it is only for estimating the amount of the toner in a developing device 5 that the amount of the “electrostatic capacity” is obtained by calculation, it is not mandatory to obtain the amount, such as 100 pf, of the electrostatic capacity. That is, the amount of the toner remaining in a developing device 5 may be calculated (estimated) by measuring the voltage which is induced in the metallic core of the development roller 25 or coating roller 24, and the amount of which is affected by the changes in the amount of the electrostatic capacity, by the detection circuit, or by measuring the electric current flowed by the voltage, by the detection circuit.

### [Miscellanies]

1) Image forming apparatuses to which the present invention is applicable are not limited to those of the electrophotographic type; not only is the present invention is applicable to electrophotographic image forming apparatuses, but also, image forming apparatuses of the electrostatic recording type, which use an electrostatically recordable dielectric member as an image bearing member, and image forming apparatuses of the magnetic recording type, which use a magnetically recordable member as an image bearing member. 2) Not only is the present invention applicable to developing apparatuses of the above described type, but also, those of the non-contact type, which use nonmagnetic toner as developer, and those of the contact type or non-contact type, which use magnetic toner as developer.

While the invention has been described with reference to the structures disclosed herein, it is not confined to the details set forth, and this application is intended to cover such modifications or changes as may come within the purposes of the improvements or the scope of the following claims.

This application claims priority from Japanese Patent Applications Nos. 216900/2009 and 159297/2010 filed Sep. 18, 2009 and Jul. 14, 2010, respectively, which are hereby incorporated by reference.

What is claimed is:

1. An image forming apparatus comprising:
an image bearing member for bearing an electrostatic latent image on a surface thereof;
a developing device including a developer accommodating chamber for accommodating a developer, a developer carrying member, provided in said developer accommodating chamber and having a first electrode member, for developing the electrostatic latent image, a developer feeding member, provided in said developer accommodating chamber in contact with said developer carrying member and having a foam layer around a second electrode member, for supplying the developer to said developer carrying member;
a holding unit holding said developing device, said holding unit being movable between a first position in which the developer is accumulated on a nip between said developer carrying member and said developer feeding member and a second position in which the developer accumulated at said nip in the first position falls; and
a detecting device for detecting a developer remainder amount in said developer accommodating chamber on the basis of a change of an electrostatic capacity between said first electrode member and said second electrode member.

2. An apparatus according to claim 1, wherein said detecting device detects the developer remainder amount in said developer accommodating chamber on the basis of an electrostatic capacity between said first electrode member and said second electrode member integrated with respect to time in a predetermined duration after said holding unit moves said developing device from the first position to the second position.

3. An apparatus according to claim 1, wherein said detecting device detects the developer remainder amount in said developer accommodating chamber on the basis of an electrostatic capacity between said first electrode member and said second electrode member differentiated with respect to time in a predetermined duration after said holding unit moves said developing device from the first position to the second position.

4. An apparatus according to claim 1, wherein said detecting device starts detection of a electrostatic capacity between said first electrode member and said second electrode member immediately after said holding unit moves said developing device from the first position to the second position.

5. An image forming apparatus comprising:
an image bearing member for bearing an electrostatic latent image on a surface thereof;
a developing device for accommodating a developer and for developing the electrostatic latent image with the developer;
a first electrode member and a second electrode member which are provided in said developing device;
a holding unit holding said developing device, said holding unit being movable between a first position in which said developing device is operable for development and a second position in which an electrostatic capacity between said first electrode member and said second electrode member which is different from that in the first position; and
a detecting device for detecting a developer remainder amount in said developing device on the basis of a change of an electrostatic capacity between said first electrode member and said second electrode member in a predetermined duration after said holding unit moves said developing device from the first position to the second position.

6. An apparatus according to claim 5, wherein said detecting device detects the developer remainder amount in said developer accommodating chamber on the basis of an electrostatic capacity between said first electrode member and said second electrode member integrated with respect to time in a predetermined duration after said holding unit moves said developing device from the first position to the second position.

7. An apparatus according to claim 5, wherein said detecting device detects the developer remainder amount in said developer accommodating chamber on the basis of an electrostatic capacity between said first electrode member and said second electrode member differentiated with respect to time in a predetermined duration after said holding unit moves said developing device from the first position to the second position.

8. An apparatus according to claim 5, wherein said detecting device starts detection of a electrostatic capacity between said first electrode member and said second electrode member immediately after said holding unit moves said developing device from the first position to the second position.

9. An apparatus according to claim 5, wherein said developing device includes a developer carrying member for carrying the developer and for developing the electrostatic latent image, a core metal and a foam layer around said core metal, a developer feeding member for supplying the developer to said developer carrying member, and when the developer remainder amount is smaller than a predetermined amount, said core metal is used as said first electrode member or said second electrode member.
